(19) United States
(12) Patent Application Publication
(10) Pub. No.: US 2016/0232554 A1
(43) Pub. Date: Aug. 11, 2016

(54) CONTROLLING RECLAIMING OF MOBILE COUPONS OR VOUCHERS

(71) Applicant: OP-PALVELUT OY, Helsinki (FI)

(72) Inventors: Jussi JUNTUNEN, HELSINKI (FI); Tuomas JOMPPANEN, HELSINKI (FI); Antti LAITALA, HELSINKI (FI); Kristian LUOMA, HELSINKI (FI)

(21) Appl. No.: 15/023,744

(22) PCT Filed: Sep. 22, 2014
(86) PCT No.: PCT/FI2014/050722

§ 371 Date: Mar. 22, 2016

(30) Foreign Application Priority Data
Sep. 23, 2013 (FI) 20135949

(51) Int. Cl. G06Q 30/02

(52) U.S. Cl. CPC G06Q 30/0225; G06Q 30/0235

(57) ABSTRACT

Apparatus and method are provided. The solution includes displaying (302) information on a retailer related benefit: detecting (304) a reclaiming action related to the benefit; transmitting (306) to a network server message including information on the reclaiming action; receiving (308) from the network server a timestamp related to the reclaiming action and a timestamp related to the expiration time of the benefit; and controlling (310) a timer to calculate the time difference of between the timestamps and displaying the timer.

### FIELD

The exemplary and non-limiting embodiments of the invention relate generally to electronic coupons or benefits in mobile devices and especially reclaiming the coupons or benefits.

### BACKGROUND

The emerging electronic media and mobile computing offer new possibilities in the communication between a consumer and retailers. Retailers have offered special benefits for loyal customers in form of membership vouchers or special discounts to all customers in form of coupons in advertisements, for example. Both forms of communication have been introduced in the mobile communication environment as electronic membership cards or electronic coupons or vouchers. A problem associated with these electronic forms of communication is controlling the reclaiming of the benefits.

### SUMMARY

The present invention seeks to provide an improved solution for controlling the reclaiming of electronic vouchers or other forms of benefits.

According to an aspect of the present invention, there is provided an apparatus, comprising: at least one processor; at least one memory including computer program code, and user interface; the at least one memory and the computer program code configured to, with the at least one processor, cause the apparatus at least to perform: control displaying information on a retailer related benefit: control detection of a reclaiming action related to the benefit; transmit to a network server information on the reclaiming action; receive from the network server a timestamp related to the reclaiming action and a timestamp related to the expiration time of the benefit; control a timer to calculate the time difference of between the timestamps; control displaying the timer.

According to an aspect of the present invention, there is provided an apparatus, comprising: at least one processor; at least one memory including computer program code, and user interface; the at least one memory and the computer program code configured to, with the at least one processor, cause the apparatus at least to perform: receive command to display a retailer related benefit; control the transmission to the network server of a message, the message comprising identification of the retailer related benefit and a query related to the validity of the benefit; receive from the network server information on the validity and timestamp information related to reclaiming of the benefit; and control displaying information on the retailer related benefit on the basis of the information.

According to an aspect of the present invention, there is provided an apparatus, comprising: at least one processor; at least one memory including computer program code, and a communication interface, the at least one memory and the computer program code configured to, with the at least one processor, cause the apparatus at least to perform: control receiving from user equipment information related to reclaiming a retailer related benefit; determine and store a timestamp related to the time instant of the reclaiming of the benefit and a timestamp related to expiration time of the benefit; control transmission of the timestamps to the user equipment.

According to another aspect of the present invention, there is provided a method, comprising: controlling displaying information on a retailer related benefit: controlling detection of a reclaiming action related to the benefit; transmitting to a network server information on the reclaiming action; receiving from the network server a timestamp related to the reclaiming action and a timestamp related to the expiration time of the benefit; controlling a timer to calculate the time difference of between the timestamps; and controlling displaying the timer.

According to another aspect of the present invention, there is provided a method, comprising: control receiving from user equipment information related to reclaiming a retailer related benefit; determine and store a timestamp related to the time instant of the reclaiming of the benefit and a timestamp related to expiration time of the benefit; control transmission of the timestamps to the user equipment.

### LIST OF DRAWINGS

Embodiments of the present invention are described below, by way of example only, with reference to the accompanying drawings, in which

FIG. 1 illustrates an example of a general operating environment applicable to some embodiments of the invention;

FIG. 2 is a signalling illustrating an embodiment of the invention;

FIGS. 3A, 3B, 4A and 4B are flowcharts illustrating embodiments of the invention;

FIGS. 5A, 5B, 5C and 5D illustrate examples of displayed retailer related benefits; and

FIGS. 6A and 6B illustrate examples of apparatuses in which some embodiments of the invention may be applied.

### DESCRIPTION OF SOME EMBODIMENTS

The following embodiments are only examples. Although the specification may refer to “an” embodiment in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may contain also features/structures that have not been specifically mentioned.

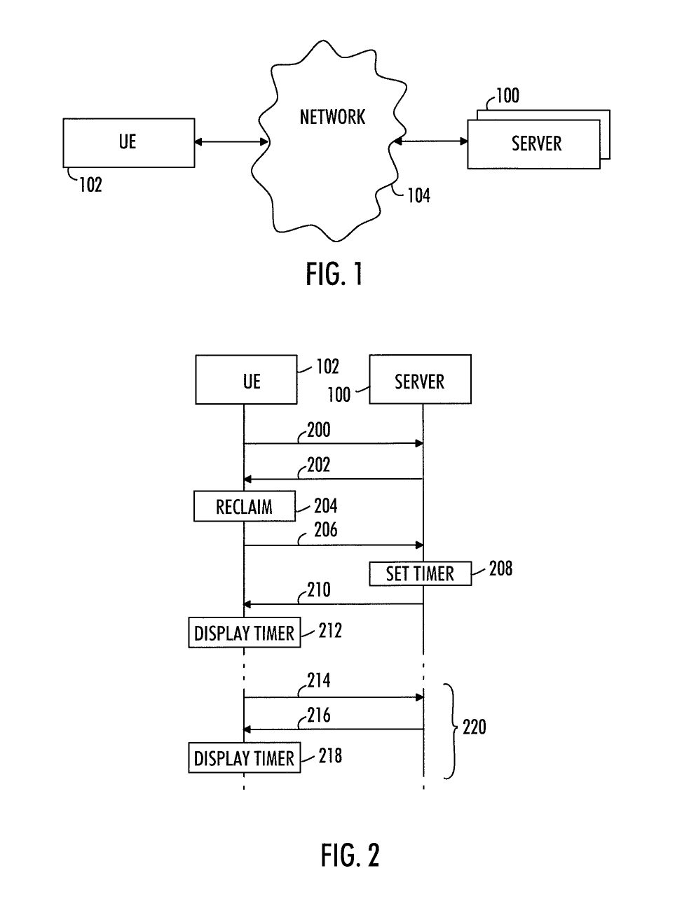

FIG. 1 illustrates an example of a general operating environment applicable to some embodiments of the invention. The environment comprises one or more network servers 100 running an service and database operations related to retailer related benefits or coupons, and user equipment 102 running software, and a communication network 104 connecting the network server 100 and the user equipment 102.

The communication network 104 may be a wired or wireless communication network or a combination of these. The network may include various wired/wireless standards, non-standard or proprietary communication networks such as a computer network, a private network, an IP-based network (TCP/IP=Transmission Control Protocol/Internet Protocol), the Internet, the telephone network including the public switched telephone network PSTN, any cellular network (such as a mobile phone network) such as GSM (Global System for Mobile Communications), GPRS (General Packet Radio Service), EGPRS (Enhanced GPRS), WCDMA (Wideband Code Division Multiple Access), UMTS (Universal Mobile Telephone System), 3GPP (The 3rd Generation Partnership Project), IMT (International Mobile Telecommunication), LTE (Long Term Evolution, LTE-A (LTE-Advanced), and other radio systems (in their present forms and/or in their evolution forms), a wireless local area network such as Wi-Fi or WLAN (Wireless Local Area

Network) based on IEEE (Institute of Electrical and Electronics Engineers) 802.11 standard or its evolution versions or WiMAX (Worldwide Interoperability for Microwave Access, for example.

User equipment 102 refers to a computing device. Such computing devices include wireless mobile communication devices operating with or without a subscriber identification module (SIM), including, but not limited to, the following types of devices: a mobile phone, a smartphone, a personal digital assistant (PDA), a tablet computer, a laptop or a table top computer.

The network server or servers 100 may be configured to offer the user equipment 102 retailer related benefit or coupon related services and database operations. The server or servers 100 may be a personal computer or a set of computers or a computer network or any other kind of processing system comprising a at least one processor; and at least one memory including computer program code. The server is configured to be accessible by users through the communication network 104, for example. The server may comprise suitable interfaces and/or transceivers to contact the communication network.

The user equipment 102 may run software configured to store and display electronic vouchers, coupons or benefits obtained from different retailers or vendors. The software may be configured to communicate with the server 100 regarding the electronic vouchers, coupons or benefits. The software may authenticate the user of the user equipment by communicating with the server 100. The server 100 may be configured to maintain a database of vouchers, coupons or benefits belonging to the user, and information which benefits are valid and which benefits have already been reclaimed and which not. The software may communicate with the server to check the validity and reclaiming status of vouchers, coupons or benefits stored in the user equipment. Some benefits may be valid for a given period of time and may be reclaimed as many times as desired. Some benefits may have a limitation that they may be reclaimed only once within a given time period.

As the vouchers, coupons or benefits are stored in the user equipment, the retailers and vendors offering these benefits need to make sure that the benefits are not misused in relation to the reclaim limitations. Physical coupons and benefits may be taken away when reclaiming occurs but a different kind of approach must be taken with electronic coupons and benefits.

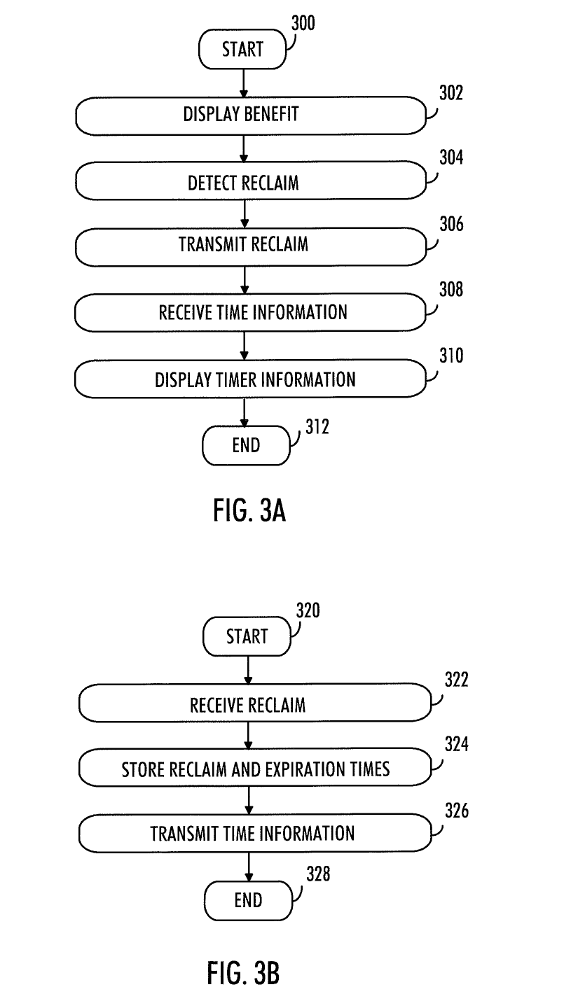

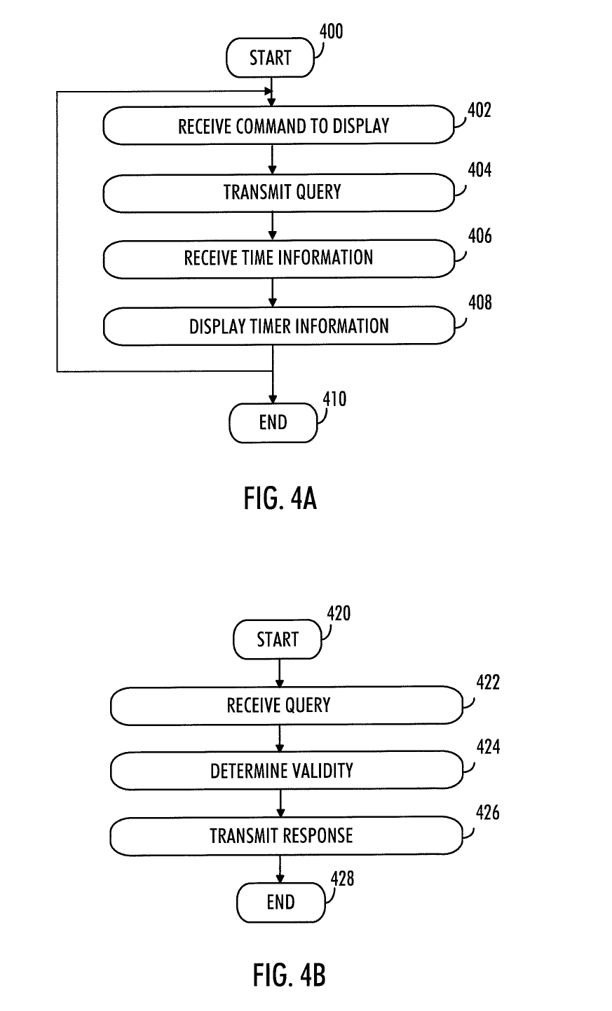

Let us study an example of an embodiment with reference to signalling chart of FIG. 2, and flowcharts of FIGS. 3A, 3B, 4A, 4B and FIGS. 5A, 5B, 5C and 5D.

FIG. 2 is a signalling chart of an example of controlling the reclaiming of electronic benefits. It is to be noted, however, that the embodiments of the invention are not limited to the presented example. Also other kind of procedures may be applied as one skilled in the art is well aware.

The example of FIG. 2 illustrates signalling between user equipment 102 and a server 100. FIGS. 3A and 4A are flowcharts illustrating the operation of user equipment 102. FIGS. 3B and 4B are flowcharts illustrating the operation of the server 100.

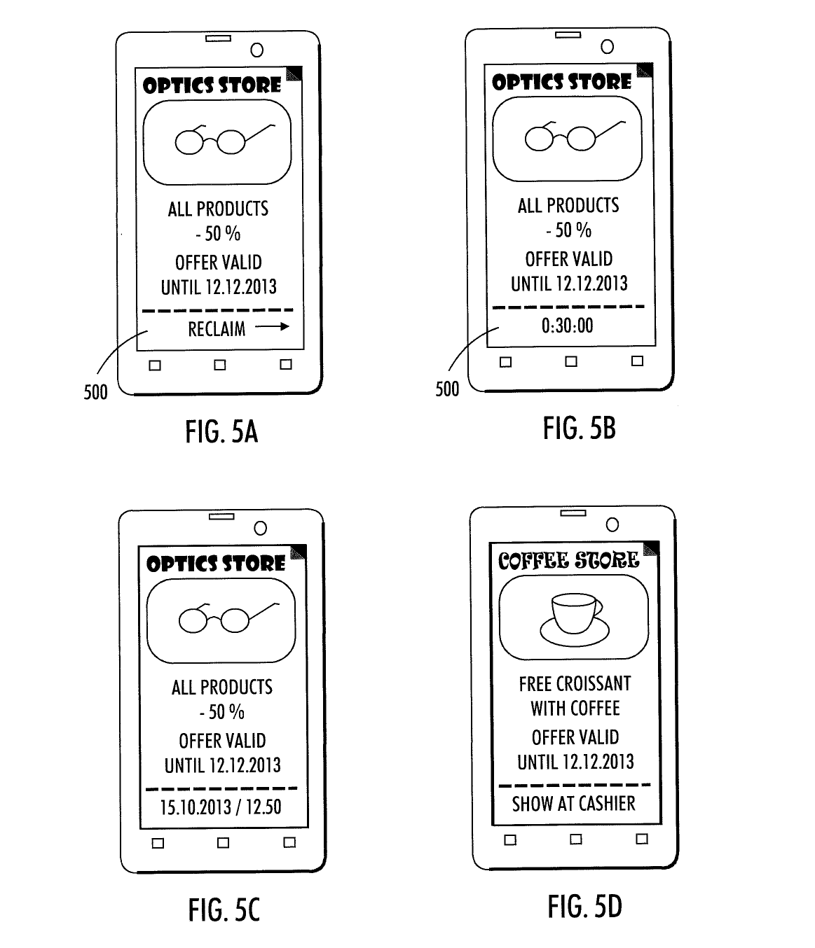

The user equipment may have stored a number of benefits the user has obtained. The user wishes to view a benefit. In an embodiment, the user equipment is configured to transmit a message 200 to the server 100, the message comprising a query regarding the validity of the benefit. The server 100 is configured to determine the validity of the benefit from the database stored in the server and transmit information 202 on the validity of the benefit to the user equipment. There may benefits with different properties. FIG. 5A illustrates a benefit which is valid for a given time period and which can be reclaimed only once. FIG. 5D illustrates a benefit which is valid for a given time period and which can be multiple times.

In this example, the benefit in question is a benefit which can be reclaimed once as FIG. 5A illustrates. The database kept by the server 100 indicates that the benefit has not yet been reclaimed. After receiving the information 202 from the server the user equipment 100 displays 204, 302 the benefit 5A. As the user equipment receives from the server information that the benefit has not yet been reclaimed the user equipment displays on the screen a field 500 indicating how to reclaim the benefit. In this example, the user equipment comprises a touch sensitive display and user equipment is configured to detect a sweeping touch on the designated field 500 the display. The user may reclaim the benefit by sweeping the designated field 500 with a finger or a stylus, for example.

The user equipment detects 304 the reclaim gesture and transmits to the server 100 a message 206, 306 comprising information on the reclaiming action.

The server receives 322 the message. The server database comprises information in the benefits. Upon receiving the reclaim message the server is configured to examine the database and detect the possible expiration time of the benefit. In this example, the database comprises information that the reclaimed benefit expires 30 minutes after the reclaim timestamp. The server is configured to determine and store 208, 324 a timestamp related to the time instant of the reclaiming of the benefit and a timestamp related to expiration time of the benefit.

The server 100 is configured to transmit 210, 326 information on the timestamps to the user equipment.

The user equipment 102 receives 406 from the server a timestamp related to the reclaiming action and a timestamp related to the expiration time of the benefit. The user equipment controls a timer to calculate the time difference of between the timestamps and displays 212, 408 the timer. In an embodiment, the timer is displayed in the same field 500 the information that the benefit had not yet been reclaimed was shown. In the example of FIGS. 5A to 5C, the reclaimed benefit expires in 30 minutes.

Thus, the user equipment receives two timestamps from the server and calculates and displays the time difference between the timestamps. In an embodiment, the user equipment stores no additional information about the expiration of the benefit. There is no data stored in the user equipment the user could manipulate.

The user equipment continues to update the timer and display the timer as long as the benefit is shown on the screen of the user equipment. There may be situations when displaying the benefit is temporarily interrupted (for example due to screensaver or running another program).

The user equipment may receive a command 402 to display the benefit again. This may be in response to user command, for example. The user equipment is configured to send a query 214, 404 to the server 100 prior displaying the benefit, the query comprising identification of the retailer related benefit.

The server 100 receives 422 the query and determines the validity and reclaim status of the benefit. If the server detects that the benefit has been reclaimed but nor expired, the server is configured to send a response 216, 426 to the query, the response comprising information on the validity of the benefit and a timestamp related to the time instant of the expiration of the benefit, a timestamp related to the time instant of the reclaiming of the benefit and a timestamp related to current time.

If the benefit has been reclaimed and expired, the response 216, 426 comprises a timestamp related to the time instant the benefit expired. The user equipment receives 406 the response.

If the response indicates that the benefit is still valid, the user equipment calculates and displays the time difference between the timestamps of current time and the expiration time. Again, the user equipment stores no additional information about the expiration of the benefit. There is no data stored in the user equipment the user could manipulate as the user equipment only displays time difference of two timestamps it received from the server.

If the displayed time difference reaches zero, the user equipment displays the expiration time of the benefit as FIG. 5C illustrates.

Likewise, if the response 406 indicates the benefit has been reclaimed and expired, the user equipment displays the expiration time of the benefit as FIG. 5C illustrates.

The above procedure 220 (steps 214-218 in FIG. 2) may be repeated every time the benefit is redisplayed on the display of the user equipment.

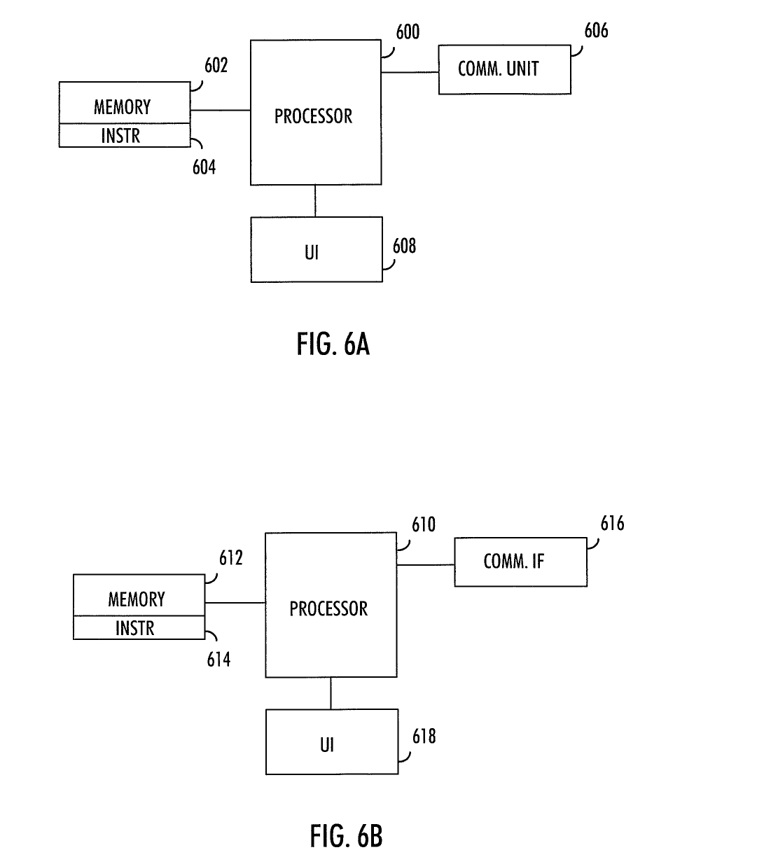

FIG. 6A illustrates an embodiment. The figure illustrates a simplified example of a device in which embodiments of the invention may be applied. In some embodiments, the device may be user equipment UE or a respective device communicating with a communications network. In some embodiments, the device may be a part of user equipment or a respective device. In general, device may be a computing device, including wireless mobile communication device operating with or without a subscriber identification module (SIM), including, but not limited to, the following types of devices: a mobile phone, a smartphone, a personal digital assistant (PDA), a tablet computer, a laptop or table top computer.

It should be understood that the apparatus is depicted herein as an example illustrating some embodiments. It is apparent to a person skilled in the art that the device may also comprise other functions and/or structures and not all described functions and structures are required. Although the device has been depicted as one entity, different modules and memory may be implemented in one or more physical or logical entities.

The device of the example includes a control circuitry 600 configured to control at least part of the operation of the device.

The device may comprise a memory 602 for storing data. Furthermore the memory may store software 604 executable by the control circuitry 600. The memory may be integrated in the control circuitry.

The device may comprise a transceiver 606. The transceiver is operationally connected to the control circuitry 600. It may be connected to an antenna arrangement (not shown).

The software 604 may comprise a computer program comprising program code means adapted to cause the control circuitry 600 of the device to control a transceiver 606.

The device may further comprise user interface 608 operationally connected to the control circuitry 600. The user interface may comprise a display which may be touch sensitive, a keyboard or keypad (which may be implemented using a touch sensitive display), a microphone and a speaker, for example.

The control circuitry 600 is configured to execute one or more applications. The applications may be stored in the memory 602. The applications may generate data traffic with the system. The applications may require data from a server in the Internet or they may store data in the server. In general the traffic generated by applications may be periodic or continuous or something in between.

Some of the above mentioned units might be accessories connectable to a device.

FIG. 6B illustrates an embodiment. The figure illustrates a simplified example of a device in which embodiments of the invention may be applied. In some embodiments, the device may be a server 100 of FIG. 1 maintaining a database and communicating with user equipment UE or respective devices via a communications network. In some embodiments, the device may be a part of a server or a respective device. In general, device may be a computing device including, but not limited to, the following types of devices: a personal computer, a server computer.

It should be understood that the apparatus is depicted herein as an example illustrating some embodiments. It is apparent to a person skilled in the art that the device may also comprise other functions and/or structures and not all described functions and structures are required. Although the device has been depicted as one entity, different modules and memory may be implemented in one or more physical or logical entities.

The device of the example includes a control circuitry 610 configured to control at least part of the operation of the device.

The device may comprise a memory or an interface 612 to a memory for storing data. Furthermore the memory may store software 614 executable by the control circuitry 610. The memory may be integrated in the control circuitry.

The device may comprise a communication interface 616. The communication interface is operationally connected to the control circuitry 610. The interface may provide the device a connection to a communication system. The connection may be wired or wireless. The interface may be a network interface card, a transceiver or any other kind of apparatus providing network connections.

The software 614 may comprise a computer program comprising program code means adapted to cause the control circuitry 610 of the device to control the communication interface 616.

The device may further comprise user interface 618 operationally connected to the control circuitry 610. The user interface may comprise a display which may be touch sensitive, a keyboard or keypad (which may be implemented using a touch sensitive display), a microphone and a speaker, for example.

The control circuitry 610 is configured to execute one or more applications. The applications may be stored in the memory 612. The applications may generate data traffic with the system. The applications may require data from a server in the Internet or they may store data in the server.

In general the traffic generated by applications may be periodic or continuous or something in between.

The applications may control the control circuitry 610 to maintain via the memory interface a connection to a database comprising information on users, benefits offered by retailers and the validity and expiration of the benefits; control receiving from user equipment information related to reclaiming a retailer related benefit; determine and store a timestamp related to the time instant of the reclaiming of the benefit and a timestamp related to expiration time of the benefit; control transmission of the timestamps to the user equipment.

Some of the above mentioned units might be accessories connectable to a device.

The steps and related functions described in the above and attached figures are in no absolute chronological order, and some of the steps may be performed simultaneously or in an order differing from the given one. Other functions can also be executed between the steps or within the steps. Some of the steps can also be left out or replaced with a corresponding step.

The apparatuses or controllers able to perform the above-described steps may be implemented as an electronic digital computer, or a circuitry that may comprise a working memory (RAM), a central processing unit (CPU), and a system clock. The CPU may comprise a set of registers, an arithmetic logic unit, and a controller. The controller or the circuitry is controlled by a sequence of program instructions transferred to the CPU from the RAM. The controller may contain a number of microinstructions for basic operations. The implementation of microinstructions may vary depending on the CPU design. The program instructions may be coded by a programming language, which may be a high-level programming language, such as C, Java, etc., or a low-level programming language, such as a machine language, or an assembler. The electronic digital computer may also have an operating system, which may provide system services to a computer program written with the program instructions.

As used in this application, the term ‘circuitry’ refers to all of the following: (a) hardware-only circuit implementations, such as implementations in only analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present.

This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

An embodiment provides a computer program embodied on a distribution medium, comprising program instructions which, when loaded into an electronic apparatus, are configured to control the apparatus to execute the embodiments described above.

The computer program may be in source code form, object code form, or in some intermediate form, and it may be stored in some sort of carrier, which may be any entity or device capable of carrying the program. Such carriers include a record medium, computer memory, read-only memory, and a software distribution package, for example. Depending on the processing power needed, the computer program may be executed in a single electronic digital computer or it may be distributed amongst a number of computers.

The apparatus may also be implemented as one or more integrated circuits, such as application-specific integrated circuits ASIC. Other hardware embodiments are also feasible, such as a circuit built of separate logic components. A hybrid of these different implementations is also feasible. When selecting the method of implementation, a person skilled in the art will consider the requirements set for the size and power consumption of the apparatus, the necessary processing capacity, production costs, and production volumes, for example.

In an embodiment, the apparatus may also be implemented as an apparatus comprising means for receiving a challenge from a network server; means for controlling a detector to obtain wirelessly from an external object information on challenge/response pairs; means for determining a response to the challenge on the basis of the obtained information; and means for transmitting the response to the network server.

It will be obvious to a person skilled in the art that, as technology advances, the inventive concept can be implemented in various ways. The invention and its embodiments are not limited to the examples described above but may vary within the scope of the claim.

1-17. (canceled)

18. An apparatus, comprising:
at least one processor;
at least one memory including computer program code, and user interface;
the at least one memory and the computer program code configured to, with the at least one processor, cause the apparatus at least to perform:
control displaying information on a retailer related benefit:
control detection of a reclaiming action related to the benefit;
transmit to a network server information on the reclaiming action;
receive from the network server a timestamp related to the reclaiming action and a timestamp related to the expiration time of the benefit;
control a timer to calculate the time difference of between the time stamps;
control displaying the timer.

19. An apparatus, comprising:
at least one processor;
at least one memory including computer program code, and user interface;
the at least one memory and the computer program code configured to, with the at least one processor, cause the apparatus at least to perform:
receive command to display a retailer related benefit;
control the transmission to the network server of a message, the message comprising identification of the retailer related benefit and a query related to the validity of the benefit;
receive from the network server information on the validity and timestamp information related to reclaiming of the benefit; and
control displaying information on the retailer related benefit on the basis of the information.

20. The apparatus of claim 18, the at least one memory and the computer program code configured to, with the at least one processor, cause the apparatus further to perform:
control the transmission of a query to the network server, the query comprising identification of retailer related benefit;
control the reception of a response from the server, the response comprising information on the validity of the benefit and timestamps related to current time, expiration time of the benefit and the reclaim time of the benefit;
control a timer to calculate the time difference of between the timestamps related to current time and the expiry time of the benefit;
control displaying the timer.

21. The apparatus of claim 20, the at least one memory and the computer program code configured to, with the at least one processor, cause the apparatus further to perform:
control displaying the expiration time of the benefit when the time difference reaches zero.

22. The apparatus of claim 18, the at least one memory and the computer program code configured to, with the at least one processor, cause the apparatus further to perform:
control the transmission of a query to the network server, the query comprising identification of retailer related benefit;
control the reception of a response from the server, the response comprising information on the validity of the benefit and timestamp related to the expiration time of the benefit;
control displaying the expiration time of the benefit.

23. The apparatus of claim 18, the at least one memory and the computer program code configured to, with the at least one processor, cause the apparatus further to perform:
control the transmission of a query to the network server, the query comprising identification of retailer related benefit;
control the reception of a response from the server, the response comprising information that the benefit is valid and not reclaimed;
control displaying the information on the benefit.

24. The apparatus of claim 18, wherein the user interface comprises a touch sensitive screen, and wherein the at least one memory and the computer program code configured to, with the at least one processor, cause the apparatus further to perform:
receive from user interface information on a touch detected on a given region of the touch sensitive screen;
determining the touch as a reclaiming action of the retailer related benefit.

25. An apparatus, comprising:
at least one processor;
at least one memory including computer program code, and a communication interface,
the at least one memory and the computer program code configured to, with the at least one processor, cause the apparatus at least to perform:
control receiving from user equipment information related to reclaiming a retailer related benefit;
determine and store a timestamp related to the time instant of the reclaiming of the benefit and a timestamp related to expiration time of the benefit;
control transmission of the timestamps to the user equipment.

26. The apparatus of claim 25, the at least one memory and the computer program code configured to, with the at least one processor, cause the apparatus further to perform:
control the reception of a message from user equipment, the message comprising a query related to validity of a retailer related benefit;
determine the validity and reclaim status of the benefit;
control the transmission of a response to the user equipment, the response comprising information on the validity of the benefit and, if the benefit has been reclaimed but nor expired, a timestamp related to the time instant of the expiration of the benefit, a timestamp related to the time instant of the reclaiming of the benefit and a timestamp related to the current time.

27. The apparatus of claim 26, wherein, if the benefit has expired, the response comprises a timestamp related to the time instant the benefit expired.

28. The apparatus of claim 25, further comprising a memory interface, wherein the processor is configured to cause the apparatus furtherto perform:
maintain via the memory interface a connection to a database comprising information on benefits offered by retailers and the validity of the benefits.

29. A method, comprising:
controlling displaying information on a retailer related benefit:
controlling detection of a reclaiming action related to the benefit;
transmitting to a network server information on the reclaiming action;
receiving from the network server a timestamp related to the reclaiming action and a timestamp related to the expiration time of the benefit;
controlling a timer to calculate the time difference of between the timestamps; and
controlling displaying the timer.

30. The method of claim 29, further comprising:
detecting that information on a retailer related benefit is about to be shown;
controlling the transmission to the network server of a message, the message comprising identification of the retailer related benefit and a query of the validity of the benefit;
receiving from the network server information on the validity and timestamp information related to reclaiming of the benefit; and
controlling displaying information on the retailer related benefit on the basis of the information.

31. The method of claim 29, further comprising:
controlling the transmission of a query to the network server, the query comprising identification of retailer related benefit;
controlling the reception of a response from the server, the response comprising information on the validity of the benefit and timestamps related to current time, expiration time of the benefit and the reclaim time of the benefit;
controlling a timer to calculate the time difference of between the timestamps related to current time and the expiry time of the benefit;
controlling displaying the timer.

32. A method, comprising:
control receiving from user equipment information related to reclaiming a retailer related benefit;
determine and store a timestamp related to the time instant of the reclaiming of the benefit and a timestamp related to expiration time of the benefit;
control transmission of the timestamps to the user equipment.

33. The method of claim 32, further comprising:
controlling the reception of a message from user equipment, the message comprising a query related to validity of a retailer related benefit;
determining the validity and reclaim status of the benefit;
controlling the transmission of a response to the user equipment, the response comprising information on the validity of the benefit and, if the benefit has been reclaimed but nor expired, a timestamp related to the time instant of the expiration of the benefit, a timestamp related to the time instant of the reclaiming of the benefit and a timestamp related to the current time.
